(19) United States
(12) Patent Application Publication
(10) Pub. No.: US 2026/0016298 A1
(43) Pub. Date: Jan. 15, 2026

(54) SENSOR UNIT AND METHOD FOR OPERATING A SENSOR UNIT

(71) Applicant: Robert Bosch GmbH, Stuttgart (DE)

(72) Inventors: Fabian Zschocke, Ludwigsburg (DE); Peter Degenfeld-Schonburg, Renningen (DE); Patrick Tritschler, Engen (DE)

(21) Appl. No.: 19/214,228

(22) Filed: May 21, 2025

(30) Foreign Application Priority Data
Jun. 4, 2024 (DE) 10 2024 205 123.3

(51) Int. Cl. G01C 19/72; G01C 19/5614; G01C 19/5712; G02B 6/293

(52) U.S. Cl. CPC G01C 19/721; G01C 19/5614; G01C 19/5712; G02B 6/29352

(57) ABSTRACT

A sensor unit. The sensor unit includes a waveguide including a first end and a second end opposite to the first end. The sensor unit includes a beam splitter, which is configured and disposed to split a light beam received from a light source and to guide a thus obtained first partial light beam into the first end of the waveguide and to guide a second partial light beam into the second end of the waveguide. The beam splitter is further configured and disposed to direct light from the first end of the waveguide to a detector unit and to direct light from the second end of the waveguide to the detector unit. The sensor unit includes the detector unit, which is configured to detect and evaluate the light from the first end of the waveguide with the light from the second end of the waveguide.

### FIELD

The present invention relates to a sensor unit and method for operating a sensor unit. The present invention also provides a computer program.

### BACKGROUND INFORMATION

MEMS sensors are compact inertial sensors comprising a mechanically oscillating Coriolis mass. However, their mechanical components make them susceptible to shocks, vibrations, Brownian noise, and temperature changes. Chip-integrated optical sensors are less susceptible to these influences and therefore promise better performance at comparable unit costs and size.

Optical gyroscopes based on the Sagnac effect can be used for the acquisition of rotation rates. In a chip-integrated embodiment, the light is continuously transmitted in two opposite directions into a wound optical waveguide. Due to the Sagnac effect, the effectively traveled length of the two light paths varies as the system rotates. This shifts the phase of the light. After passing through the waveguide, the two light paths meet again and the light waves are superposed. Constructive and destructive interference occurs, which results in a light wave the intensity of which can be measured and varies in proportion to the rotation rate. However, only one axis of rotation can be measured in this way.

It is also possible to measure a rotation rate using optomechanical coupling. Due to the influence of a moving Coriolis mass on the refractive index of a light guide or an optical resonator, phase shifts can be used as a measurement signal by Mach-Zehnder interferometers (MZI). However, all of the conventional solutions have problems with respect to a compact, chip-integrated sensor having a small installation space and with highly sensitive and precise three-axis rotation rate determination.

### SUMMARY

The present invention provided a sensor unit, a method for operating a sensor unit, a control unit that uses this method, and a corresponding computer program product. Advantageous developments and improvements of the sensor unit are made possible by the measures disclosed herein.

The present invention provides a sensor unit. According to an example embodiment of the present invention, the sensor unit has the following features:
a waveguide comprising a first end and a second end opposite to the first end;
a beam splitter, which is configured and disposed to split a light beam received from a light source and to guide a thus obtained first partial light beam into the first end of the waveguide and to guide a second partial light beam into the second end of the waveguide, wherein the beam splitter is further configured and disposed to direct light from the first end of the waveguide to a detector unit and to direct light from the second end of the waveguide to the detector unit; and
the detector unit, which is configured to detect and evaluate the light from the first end of the waveguide with the light from the second end of the waveguide.

A waveguide can be understood to be an optical or dielectric fiber, for instance, that is capable of guiding electromagnetic waves between a first end and a second end. A beam splitter can be understood to be an optical element that is capable of shaping and directing a light beam, for example splitting it into multiple partial light beams. The beam splitter can be configured as a partially transparent mirror or a partially transparent prism, for instance, or chip-integrated as a multimode interferometer to allow a first partial light beam to pass through and to deflect a second partial light beam. At the same time, the beam splitter can also be designed to direct light emerging from the first end of the waveguide onto the detector unit and to likewise direct light emerging from the second end of the waveguide onto the detector unit. The beam splitter thus then assumes the function of a directional element to bundle light from different directions and direct it into a common detector unit.

The approach presented here according to the present invention is based on the insight that light can pass through a waveguide in both directions and that the effective length of this waveguide changes when the waveguide moves, for example when it rotates, due to the Sagnac effect. This makes it possible to evaluate interference between the light from the first end to the second end of the waveguide with the light from the second end of the waveguide to the first end of the waveguide, for example to obtain information about the magnitude of the movement or the rotation of the sensor unit.

The present invention has the advantage of being able to efficiently measure a physical parameter using very few components, in particular the waveguide, through which light passes in two directions. In addition to the realization of a very small assembly, utilizing the physical principles of the Sagnac effect also enables a precise and cost-efficient measurement of specific parameters by means of the sensor unit.

A favorable example embodiment of the present invention is one in which the waveguide has a spiral structure and/or is configured as a Mach-Zehnder interferometer and/or comprises a phase shifting element and/or wherein the beam splitter is configured as an at least partially transparent mirror. Such an embodiment has the advantage that only a small amount of space is required for the arrangement of the waveguide, or that the use of one or more corresponding phase shifting elements can achieve a desired predistortion of the photons in order to then be able to determine a physical quantity very precisely. The use of an at least partially transparent mirror as a beam splitter also enables an assembly with a small space requirement.

In order to be able to produce an assembly of the sensor unit that is as fully integrated as possible, according to another example embodiment of the present invention, a light source that is configured and aligned to emit a light beam onto the beam splitter can be provided. The optical path can also be implemented in a chip-integrated manner using chip-integrated optical components.

Another example embodiment of the present invention is possible, in which the detector unit is configured to receive a signal that represents a movement and/or a rotation of the sensor unit as the sensor signal. Such an embodiment has the advantage that such a sensor unit can acquire a respective movement or rotation of the sensor unit in a particularly cost-effective yet precise manner.

Another advantageous example embodiment of the present invention is one that comprises at least one Coriolis mass element which is suspended such that it can move in a direction of oscillation relative to at least one fixed point. An oscillating Mach-Zehnder interferometer is provided, which is configured to detect a movement of the Coriolis mass element in the direction of oscillation, in particular wherein the oscillating Mach-Zehnder interferometer is disposed at a predefined distance to the Coriolis mass element and/or the oscillating Mach-Zehnder interferometer is configured or disposed to acquire a movement of the sensor unit that differs from a movement that can be acquired by the waveguide and the detector unit. A Coriolis mass element can be understood to be an element or body that is suspended such that it can move relative to a fixed point, for example a housing. Such an embodiment of the approach proposed here has the advantage of being able to acquire a further physical quantity or a further parameter, in particular a movement parameter, by means of the sensor unit. The acquisition using or utilizing optical relationships can in particular also enable a very precise acquisition of these quantities or parameters.

Also possible is an embodiment of the present invention in which the Coriolis mass element is suspended such that it can move in a further direction of oscillation relative to at least one further fixed point, wherein a further oscillating Mach-Zehnder interferometer is provided, which is configured to detect a movement of the Coriolis mass element in the further direction of oscillation, in particular wherein the further oscillating Mach-Zehnder interferometer is disposed at a predefined further distance to the Coriolis mass element and/or wherein the further oscillating Mach-Zehnder interferometer is configured or disposed to acquire a movement of the sensor unit that differs from the direction of oscillation and the movement that can be acquired by the waveguide and the detector unit. Such an embodiment has the advantage of implementing an especially precise measurement of this quantity also by using optical measuring elements to measure a physical quantity in a further direction of movement or direction of oscillation. Specifically the use of the Coriolis mass element can prove particularly favorable if this Coriolis mass element is also used to measure the quantity in the further direction of movement or direction of oscillation. Using the Coriolis mass element for both the parameter or the quantity in the direction of oscillation and in the further direction of oscillation, makes it possible to realize a measuring element with a small installation space requirement.

According to a further example embodiment of the present invention, a phase shifting element can be provided on a path of the oscillating Mach-Zehnder interferometer and/or the further oscillating Mach-Zehnder interferometer, and/or at least one beam splitting element is provided, which is configured to split light falling onto the beam splitting element into partial light beams that are each directed into the oscillating Mach-Zehnder interferometer and the further oscillating Mach-Zehnder interferometer. Such an embodiment of the approach proposed here provides the ability of particularly favorably being able to set a sensitivity of the oscillating Mach-Zehnder interferometer or the further oscillating Mach-Zehnder interferometer by parameterizing the phase shifting element. The use of a corresponding beam splitting element enables the compact design of the sensor unit in which light from the light source or an auxiliary light source can be directed into the corresponding oscillating Mach-Zehnder interferometer.

Also advantageous is an example embodiment of the present invention in which a detection element is provided that is configured to ascertain the movement of the Coriolis mass element in the direction of oscillation or the further direction of oscillation by evaluating a change in the refractive index caused by a change in the distance between the Coriolis mass element and a path of the oscillating Mach-Zehnder interferometer and/or between the Coriolis mass element and a path of the further oscillating Mach-Zehnder interferometer. Such an embodiment has the advantage of obtaining a precise measurement result via an optical effect, so that deterioration in the measured value due to wear symptoms during operation of the sensor unit, for instance, has as little effect as possible.

An embodiment of the approach presented here, in which the light source is configured to direct light into the oscillating Mach-Zehnder interferometer and/or the further oscillating Mach-Zehnder interferometer, can be realized in a particularly compact and space-saving manner. Such an embodiment has the advantage that, by using the light source that is, for example, implemented in an integrated circuit with the other components of the sensor unit, a compact and autonomously usable sensor unit, the operation of which can be disrupted as little as possible by external effects, is created.

The aforementioned advantages can also be achieved by an embodiment of the present invention as a method for operating a variant of a sensor unit presented here, wherein the method comprises the following steps:
illuminating at least the beam splitter with a light to guide a first partial light beam into the first end of the waveguide and to guide a second partial light beam into the second end of the waveguide; and
detecting and evaluating the light received in the detector unit to obtain a sensor signal.

This method can be implemented in software or hardware, for instance, or in a mixed form of software and hardware, for example in a control device or a control unit.

The present invention also provides a control unit that is configured to carry out, control or implement the steps of a variant of a method of the present invention disclosed herein in corresponding devices. This design variant of the present invention in the form of a control unit can likewise achieve the underlying object of the present invention quickly and efficiently.

For this purpose, the control unit can comprise at least one computing unit for processing signals or data, at least one memory unit for storing signals or data, at least one interface to a sensor or an actuator for reading in sensor signals from the sensor or for outputting data or control signals to the actuator, and/or at least one communication interface for reading in or outputting data embedded in a communication protocol. The computing unit can be a signal processor, a microcontroller or the like, for example, and the memory unit can be a flash memory or a magnetic memory unit. The communication interface can be configured to read in or output data wirelessly and/or by wire, wherein a communication interface capable of reading in or outputting data transmitted by wire can read said data, for example electrically or optically, from a respective data transmission line or output the data to a respective data transmission line.

A control unit can be understood here to be an electrical device that processes sensor signals and outputs control signals and/or data signals as a function thereof. The control unit can comprise an interface which can be implemented as hardware and/or software. When implemented as hardware, the interfaces can be part of a so-called system ASIC, for example, which contains various functions of the control unit. However, it is also possible that the interfaces are dedicated integrated circuits or consist at least partly of discrete components. When implemented as software, the interfaces can be software modules present, for example, on a microcontroller alongside other software modules.

The present invention also provides a control unit that is configured to carry out, control or implement the steps of a variant of a method presented here in corresponding devices.

This design variant of the present invention in the form of a control unit can likewise achieve the underlying object of the present invention quickly and efficiently.

For this purpose, the control unit can comprise at least one computing unit for processing signals or data, at least one memory unit for storing signals or data, at least one interface to a sensor or an actuator for reading in sensor signals from the sensor or for outputting control signals to the actuator, and/or at least one communication interface for reading in or outputting data embedded in a communication protocol. The computing unit can be a signal processor, a microcontroller or 9 Substitute Specification the like, for example, and the memory unit can be a flash memory or a magnetic memory unit. The communication interface can be configured to read in or output data wirelessly and/or by wire, wherein a communication interface capable of reading in or outputting data transmitted by wire can read said data, for example electrically or optically, from a respective data transmission line or output the data to a respective data transmission line.

A control unit can be understood here to be an electrical device that processes sensor signals and outputs control signals and/or data signals as a function thereof. The control unit can comprise an interface that can be configured as hardware and/or software. When implemented as hardware, the interfaces can be part of a so-called system ASIC, for example, which contains various functions of the control unit. However, it is also possible that the interfaces are dedicated integrated circuits or consist at least partly of discrete components. When implemented as software, the interfaces can be software modules present, for example, on a microcontroller alongside other software modules.

A computer program product or a computer program comprising program code that can be stored on a machine-readable carrier or storage medium, such as a semiconductor memory, a hard disk memory or an optical memory, and can be used to carry out, implement and/or control the steps of the method according to one of the above-described embodiments of the present invention is advantageous as well, in particular when the program product or program is executed on a computer or a control unit.

Embodiment examples of the present invention are shown in the figures and explained in more detail in the following description.

### BRIEF DESCRIPTION OF THE DRAWINGS

FIG. 1 shows a schematic illustration of an embodiment example of a sensor unit according to the present invention.

FIG. 2 shows a schematic illustration of an embodiment example of the first sensor element as a Sagnac gyroscope, according to the present invention.

FIG. 3 shows a schematic illustration of the structure of the second sensor element, according to an example embodiment of the present invention.

FIG. 4 shows a flow chart of an embodiment example of a method for operating a variant of a sensor unit presented here according to the present invention.

FIG. 5 shows a block diagram of an embodiment example of a control unit for carrying out a method for operating a variant of a sensor unit according to the present invention.

### DETAILED DESCRIPTION OF EXAMPLE EMBODIMENTS

In the following description of favorable embodiment examples of the present invention, the same or similar reference signs are used for the elements which are shown in the various figures and have a similar effect, and a repeated description of these elements is omitted.

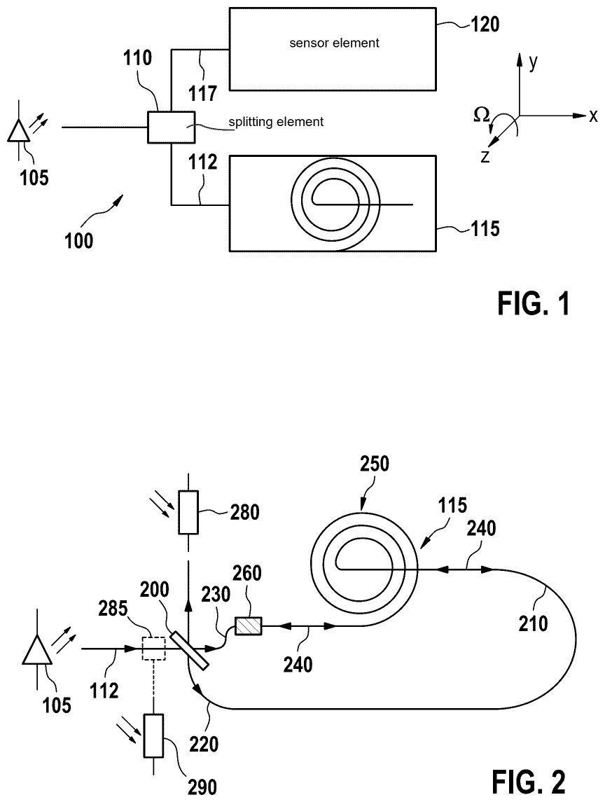

FIG. 1 shows a schematic illustration of an embodiment example of a sensor unit 100 presented here. The sensor unit 100 can be configured as an integrated semiconductor component, for example. However, it is also possible that only individual parts of the sensor unit 100 are integrated into a common chip and can, for instance, receive light from an external light source 105. The light from the light source 105, which can be external or integrated on a chip together with the other components of the sensor unit 100, is split in a splitting element 110, for example an optical beam splitter, and is guided accordingly via a first light guide 112 into a first sensor element 115 and via a second light guide 117 into a second sensor element 120. The first of the sensor elements 115 can be configured as a Sagnac gyroscope, for example, whereas the second sensor element 120 is configured as a Coriolis gyroscope.

FIG. 1 thus shows a combined, for example chip-integrated, structure consisting of a Sagnac gyroscope and an optomechanical gyroscope for rotation rate measurement in all three spatial directions. The same light source 105, for example a laser source, can be used for both sensor elements 115 and 120. The Sagnac gyroscope as the first sensor element 115 detects rotation rates Ω about the z-axis, for instance. The Coriolis gyroscope as the second sensor element 120 detects rotation rates around the x- and the y-axis. Using different gyroscopes also makes it possible to significantly improve the precision of the detection of rotations of the sensor unit 100 by evaluating different physical quantities or their effects.

FIG. 2 shows a schematic illustration of an embodiment example of the first sensor element 115 as a Sagnac gyroscope. This sensor element 115 is fed here by the light source 105 through the first light guide 112, wherein the light from the first light guide hits a beam splitter 200, which is configured as a 12 Substitute Specification partially transparent mirror, for example. The first sensor element 105 also comprises a waveguide second zero with a first end 220 and a second end 230. By means of the beam splitter 200, the light, more specifically a partial light beam from this light, is coupled from the first light guide 112 into the first end 220 of the waveguide 210, while another partial light beam from this light is coupled from the first light guide 112 into the second end 230 of the waveguide 210. In the waveguide 210, there are now two oppositely directed light beams as indicated by the bidirectional arrows with the reference sign 240. The waveguide 210 is furthermore arranged in the shape of a spiral in a section 250, and additionally comprises a phase shifting element 260 in the region of the second end 230 in order to be able to set a corresponding phase shift during transit through the phase shifting element 260.

From the first end 220 and the second end 230, a partial light beam passing through the waveguide 210 is subsequently directed back to the beam splitter 200, via which the respective partial light beams are then guided into a detection unit 280. In the detection unit 280, interference between these two partial light beams can then be used to draw conclusions about the movement or rotation of the first sensor element 115. It is also possible that a circulator 285, which allows light from the light source 105 to pass through to the beam splitter 200, is provided in or on the light guide 112. The light that is reflected back by the beam splitter 200 leaves by another output on the circulator 285, however. The light can therefore be measured with a second detection unit 290 (for example a photodiode) and a differential measurement can be carried out using a signal from the detection unit 280. This makes it possible to monitor the functionality or any errors or malfunctions that may have occurred.

FIG. 2 thus shows a schematic structure of the proposed optical part or the first sensor element 115 of the rotation rate sensor as the sensor unit 100. Light is continuously transmitted in two opposite directions into the waveguide 210. Due to the Sagnac effect, the effective length traveled by the two light paths varies as the system or the first sensor element 115 or generally the sensor unit 100 rotates, which can then be determined by evaluating the interference of the two partial light beams traveling in different directions through the waveguide 210.

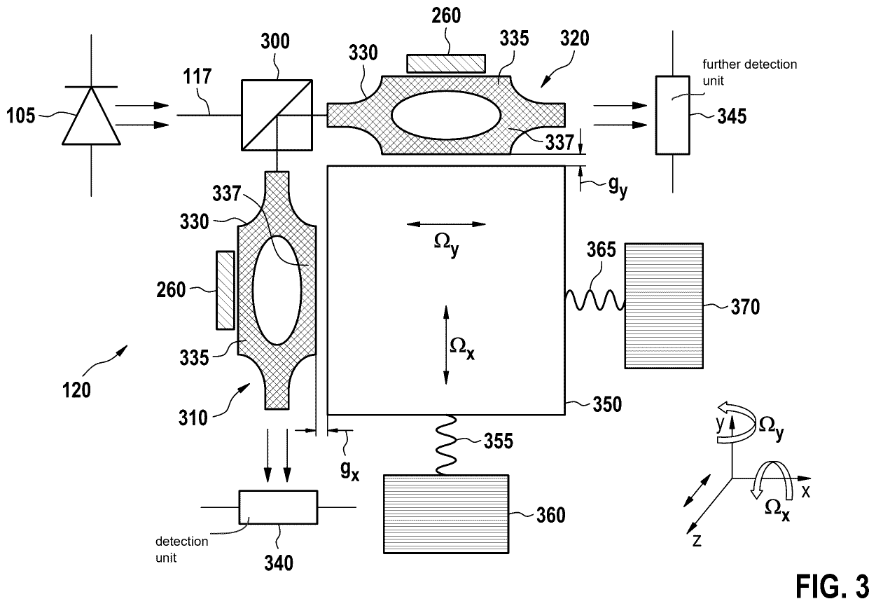

FIG. 3 shows a schematic illustration of the structure of the second sensor element 120, which is configured here as a Coriolis gyroscope. The second sensor element 120 is in turn provided with a respective light beam by the light source 105 (which is disposed externally to the sensor unit 100 or integrated on a common chip with the sensor unit 100) via the second light guide 117. The light beam from the second light guide 117 is fed via a beam splitting element 300 to a respective Mach-Zehnder interferometer, which for ease of differentiation is referred to as an oscillating Mach-Zehnder interferometer 310 and a further oscillating Mach-Zehnder interferometer 320. Each one of these oscillating Mach-Zehnder interferometers 310 or 320 includes a waveguide element 330 that comprises a first path and a second path 337 into which a portion of the light coupled into the respective oscillating Mach-Zehnder interferometer 310 or 320 by the beam splitting element 300 is guided. On a first path 335 of the respective oscillating Mach-Zehnder interferometer 310 or 320, an (optical) phase shifting element 260 is provided; for example to be able to vary the phase or intensity of photons traveling in the first path 335.

Light traveling through the oscillating Mach-Zehnder interferometer 310 can then be evaluated by a detection unit 340 (for example by utilizing interference effects). Similarly, light traveling through the further oscillating Mach-Zehnder interferometer 320 can be evaluated by a further detection unit 345 (for example also by utilizing interference effects). The Mach-Zehnders 310 and/or 320 can furthermore also each have two outputs, and each output can respectively be measured or monitored by a photodiode or a detection unit. If the signals at the respective outputs of a Mach-Zehnder 310 and/or 320 are subtracted from one another, a differential measurement can be realized, which enables greater robustness of the system.

The evaluation of light effects by means of the oscillating Mach-Zehnder interferometer 310 or by means of the further oscillating Mach-Zehnder interferometer 20 thus enables detection of a movement of a Coriolis mass element 350, which is suspended such that it can move; for example via a first spring 355 with a first fixed point 360 (for example a part of a housing of the sensor unit 100) and/or via a second spring 365 with a second fixed point 370 (for example also in a part of a housing of the sensor unit 100). The Coriolis mass element 350 is disposed here at a distance gₓ from the second path 337 of the oscillating Mach-Zehnder interferometer 310 and at a further distance g_{y} from the second path 337 of the further oscillating Mach-Zehnder interferometer 320. The Coriolis mass element 350 can be driven in a z-direction, for example, and thus set into oscillation. If there are also rotational forces acting on the Coriolis mass element 350 in the x- and/or y-direction, a resulting change in the distance gₓ and/or the further distance g_{y} causes a change in the refractive index of the material of the second path 337 of the waveguide 330 of the oscillating Mach-Zehnder interferometer 310 or the further oscillating Mach-Zehnder interferometer 320, which in turn causes a change in the transit time of the light through the respective second paths 337 that can subsequently be acquired in the detection unit 340 or the further detection unit 345. The corresponding rotation in the x- and/or y-direction of the sensor unit 100 or the second sensor element 120 can then be inferred from the result of the detection unit 340 and the further detection unit 345.

FIG. 3 thus shows a schematic structure of the proposed optomechanical part as the second sensor element 120 of the rotation rate sensor as the sensor unit 100. Upon rotation Ω of the sensor or the sensor unit 100, the Coriolis mass or mass element 350 is deflected and interacts with the electrical field of the light guide or the second path 337 of the respective oscillating Mach-Zehnder interferometer.

In summary, it can be noted that light from a light or laser source can be generated either directly on an optical chip of the sensor unit 100 or coupled into it via grating coupling structures not shown in the figures. In the second option, the laser or light source can be positioned directly above the grating coupler, and light from the grating coupler can be guided into a waveguide via a taper structure.

A Sagnac sensor, for instance, as shown in FIG. 2, is used to determine the rotation rate of the sensor unit 100 in one spatial direction. The (laser) light is split at a first beam splitter 200 and passes through the sensor region of the waveguide 210, in each case in clockwise direction and in counterclockwise direction. The Sagnac effect is at work here, resulting in a phase shift depending on the applied rotation rate. The circulating laser beams (in this case the partial light beams) then meet again in the beam splitter 200. The resulting interference signal can be measured with a photodetector or the detector unit 280 and used to determine the rotation rate.

The sensitivity of the Sagnac sensor can similarly also be increased by utilizing quantum states.

According to a further embodiment example, a ring gyroscope can be used instead of the sensor shown in FIG. 2.

Rotation rates in other spatial directions are measured using an optomechanical method, for example. The sensor component, which here corresponds to the second sensor element 120, consists of a Coriolis mass 350, as used in MEMS sensors and as shown in FIG. 3. This mass 350 should be suspended such that it can move, e.g. on corresponding mechanical spring structures 355 or 365 that are in turn attached to a fixed substrate 360 and 370. It is actuated electrostatically, for example, which results in an oscillation movement in drive direction along the z-axis. This mass 350 is also suspended such that it can move in the determination direction. If the moving mass experiences a rotation speed Ω, the Coriolis force leads to a movement of the moving mass 350 along the determination direction and thus to a change in the distance from a fixed structure.

This change in distance can advantageously be read out optically with the aid of a Mach-Zehnder interferometer. This coupling effectively leads to a change in the refractive index in one arm (here the second path 337) of the respective Mach-Zehnder interferometer MZI 310 or 320, which results in phase accumulation in this arm 337 relative to the other arm 335.

The phase difference Ao between the two arms of the MZI serves as the measurement signal for the proposed rotation rate sensor. This phase difference is given by

$$Δϕ = \frac{2 π}{λ} {Ln}_{eff} ( {g}_{x , y} ) ,$$

wherein L is the length of the waveguide, gₓ or g_{y} is the distance of the waveguide of the MZI from the Coriolis mass and n_{eff} is the effective refractive index of the waveguide. The phase offset, then, is in good approximation proportional to the deflection of the Coriolis mass in the determination direction because

$$Δϕ ∼ {n}_{eff} ( {g}_{i} ) \approx \frac{\partial {n}_{eff}}{\partial g} {\vert}_{g = {g}_{0}} i ,$$

wherein i=x, y indicates the deflection of the Coriolis mass in the determination direction. For high sensitivity, one arm of the MZI is placed close to the Coriolis mass (˜10-200 nm). An optical phase shifter (e.g. an electro-optical phase shifter (Kerr or Pockels effect) or heating elements, or a corresponding doping) on the other arm of the MZI ensures a phase offset between the two arms of the MZI independent of the mechanical coupling. This allows the phase offset to be set such that the sensitivity to deflection is greatest.

Photodetectors 340 or 345 can be used to measure the interference signal and determine the rotation rate.

To guarantee differential evaluation, the concept can also be implemented in a multi-axis arrangement or in an arrangement with doubled moving masses. Rotation rates can thus be determined analogously in all three spatial directions. This requires an additional MZI structure above or below the moving mass. The laser light is distributed to the MZI structures in the three spatial directions by means of a beam splitter.

Other optical methods for determining the change in distance are possible, too.

If the rotation rates in all three spatial directions are determined optomechanically, the Sagnac gyroscope 115 generates an additional measurement signal for one of the three spatial directions. Combining the signals makes it possible to correct errors, expand the measurement range and maintain the signal accuracy for an extended period of time.

The Sagnac gyroscope 115 and the Coriolis gyroscope 120 can use light from the same light source 105, for example a laser source.

Compared to current optical gyroscopes that are very large or limited to measuring the rotation rate of one axis, the approach presented here is based on a compact, chip-integrated sensor solution for ideally measuring the rotation rate in multiple or all three spatial directions (x, y, z).

An architecture is used, in which the rotation rate around the main axis is determined optically using the Sagnac effect, while the rotation rate around the other two axes is determined optomechanically.

The advantages that can be achieved with the approach presented here can be summarized as follows:
Such a sensor unit makes it possible to achieve high sensitivity.
Such a sensor unit makes it possible to achieve high accuracy.
Rotation rate measurement in all three spatial directions is technically simple.
Both gyroscopes can use the same optical components.
Both gyroscopes can use the same laser source.
Such a sensor unit has to only be small in size.
Conventional production processes can be used.

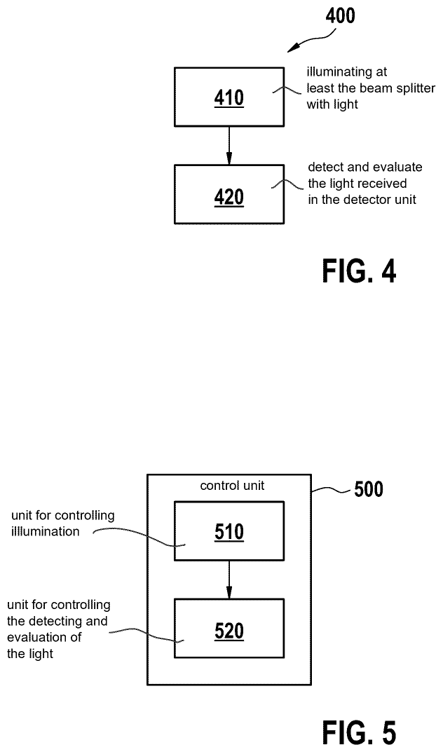

FIG. 4 shows a flow chart of an embodiment example of a method 400 for operating a variant of a sensor unit presented here, wherein the method 400 comprises a step 410 of illuminating at least the beam splitter with a light to guide a first partial light beam into the first end of the waveguide and to guide a second partial light beam into the second end of the waveguide. The method 400 further comprises a step 420 of detecting and evaluating the light received in the detector unit.

FIG. 5 shows a block diagram of an embodiment example of a control unit for carrying out a method 400 for operating a variant of a sensor unit presented here, wherein the control unit 500 comprises a unit 510 for controlling the illumination of at least the beam splitter with a light to guide a first partial light beam into the first end of the waveguide and to guide a second partial light beam into the second end of the waveguide. The control unit 500 further comprises a unit 520 for controlling the detection and evaluation of the light received in the detector unit to obtain a sensor signal.

If an embodiment example comprises an “and/or” conjunction between a first feature and a second feature, this is to be read to mean that the embodiment example comprises both the first feature and the second feature according to one embodiment, and either only the first feature or only the second feature according to another embodiment.

1-13 (canceled)

14. A sensor unit, comprising:
a waveguide having a first end and a second end (230) opposite to the first end;
a beam splitter configured and disposed to split a light beam received from a light source into first and second partial light beams and to guide the first partial light beam into the first end of the waveguide and to guide the second partial light beam into the second end of the waveguide, wherein the beam splitter is further configured and disposed to direct light from the first end of the waveguide to a detector unit and to direct light from the second end of the waveguide to the detector unit; and
the detector unit, wherein the detector unit is configured to detect and evaluate the light from the first end of the waveguide with the light from the second end of the waveguide.

15. The sensor unit according to claim 14, wherein: (i) the waveguide has a spiral structure and/or is configured as a Mach-Zehnder interferometer and/or includes a phase shifting element, and/or (ii) the beam splitter is configured as an at least partially transparent mirror.

16. The sensor unit according to claim 14, further comprising the light source, the light source being configured and aligned to emit the light beam onto the beam splitter.

17. The sensor unit according to claim 14, wherein the detector unit is configured to receive a sensor signal that represents a movement and/or a rotation of the sensor unit.

18. The sensor unit according to claim 14, further comprising at least one Coriolis mass element which is suspended such that it can move in a direction of oscillation relative to at least one fixed point, wherein an oscillating Mach-Zehnder interferometer is provided, which is configured to detect a movement of the Coriolis mass element in the direction of oscillation, wherein: (i) the oscillating Mach-Zehnder interferometer is disposed at a predefined distance to the Coriolis mass element and/or (ii) the oscillating Mach-Zehnder interferometer is configured or disposed to acquire a movement of the sensor unit that differs from a movement that can be acquired by the waveguide and the detector unit.

19. The sensor unit according to claim 18, wherein the Coriolis mass element is suspended such that it can move in a further direction of oscillation relative to at least one further fixed point, wherein a further oscillating Mach-Zehnder interferometer is provided, which is configured to detect a movement of the Coriolis mass element in the further direction of oscillation, wherein: (i) the further oscillating Mach-Zehnder interferometer is disposed at a predefined further distance to the Coriolis mass element and/or (ii) the further oscillating Mach-Zehnder interferometer is configured or disposed to acquire a movement of the sensor unit that differs from the direction of oscillation and the movement that can be acquired by the waveguide and the detector unit.

20. The sensor unit according to claim 19, wherein: (i) a phase shifting element is provided on a path of the oscillating Mach-Zehnder interferometer and/or the further oscillating Mach-Zehnder interferometer, and/or (ii) at least one beam splitting element is provided, which is configured to split light falling onto the beam splitting element into partial light beams that are each directed into the oscillating Mach-Zehnder interferometer and the further oscillating Mach-Zehnder interferometer.

21. The sensor unit according to claim 19, further comprising a detection element, which is configured to ascertain the movement of the Coriolis mass element (350) in the direction of oscillation or the further direction of oscillation by evaluating a change in a refractive index caused by a change in distance: (i) between the Coriolis mass element and a path of the oscillating Mach-Zehnder interferometer and/or (ii) between the Coriolis mass element and a path of the further oscillating Mach-Zehnder interferometer.

22. The sensor unit according to claim 19, wherein the light source is configured to direct light into the oscillating Mach-Zehnder interferometer and/or the further oscillating Mach-Zehnder interferometer.

23. A method for operating a sensor unit, the sensor unit including:
a waveguide having a first end and a second end (230) opposite to the first end,
a beam splitter configured and disposed to split a light beam received from a light source into first and second partial light beams and to guide the first partial light beam into the first end of the waveguide and to guide the second partial light beam into the second end of the waveguide, wherein the beam splitter is further configured and disposed to direct light from the first end of the waveguide to a detector unit and to direct light from the second end of the waveguide to the detector unit, and
the detector unit, wherein the detector unit is configured to detect and evaluate the light from the first end of the waveguide with the light from the second end of the waveguide;
the method comprising the following steps:
illuminating at least the beam splitter with a light to guide the first partial light beam into the first end of the waveguide and to guide the second partial light beam into the second end of the waveguide; and
detecting and evaluating the light received in the detector unit to obtain a sensor signal.

24. A control unit configured to operate a sensor unit, the sensor unit including:
a waveguide having a first end and a second end (230) opposite to the first end,
a beam splitter configured and disposed to split a light beam received from a light source into first and second partial light beams and to guide the first partial light beam into the first end of the waveguide and to guide the second partial light beam into the second end of the waveguide, wherein the beam splitter is further configured and disposed to direct light from the first end of the waveguide to a detector unit and to direct light from the second end of the waveguide to the detector unit, and
the detector unit, wherein the detector unit is configured to detect and evaluate the light from the first end of the waveguide with the light from the second end of the waveguide,
the control unit configured to:
illuminate at least the beam splitter with a light to guide the first partial light beam into the first end of the waveguide and to guide the second partial light beam into the second end of the waveguide; and
detect and evaluate the light received in the detector unit to obtain a sensor signal.

25. A non-transitory machine-readable storage medium on which is stored a computer program for operating a sensor unit, the sensor unit including:
a waveguide having a first end and a second end (230) opposite to the first end,
a beam splitter configured and disposed to split a light beam received from a light source into first and second partial light beams and to guide the first partial light beam into the first end of the waveguide and to guide the second partial light beam into the second end of the waveguide, wherein the beam splitter is further configured and disposed to direct light from the first end of the waveguide to a detector unit and to direct light from the second end of the waveguide to the detector unit, and
the detector unit, wherein the detector unit is configured to detect and evaluate the light from the first end of the waveguide with the light from the second end of the waveguide,
the computer program, when executed by a computer, causing the computer to perform the following steps:
illuminating at least the beam splitter with a light to guide the first partial light beam into the first end of the waveguide and to guide the second partial light beam into the second end of the waveguide; and
detecting and evaluating the light received in the detector unit to obtain a sensor signal.
